(19) United States
(12) Patent Application Publication
(10) Pub. No.: US 2017/0139067 A1
(43) Pub. Date: May 18, 2017

(54) PARALLEL PROCESSING SEISMIC WAVEFIELD DATA

(71) Applicant: WESTERNGECO LLC, Houston, TX (US)

(72) Inventors: Can Evren Yarman, Cambridge (GB); Garret Flagg, Houston, TX (US)

(73) Assignee: WESTERNGECO LLC, Houston, TX (US)

(21) Appl. No.: 15/318,480

(22) PCT Filed: Jul. 1, 2015
(86) PCT No.: PCT/US2015/038742

§ 371 Date: Dec. 13, 2016

Related U.S. Application Data
(60) Provisional application No. 62/020,503, filed on Jul. 3, 2014.

(51) Int. Cl. G01V 1/36

(52) U.S. Cl. CPC G01V 1/36

(57) ABSTRACT

Computing systems, methods, and computer-readable media for parallel processing an electronic representation of an approximation of a seismic wavefield while preserving spectral properties is presented. The technique may include obtaining, by at least one electronic processor, data representing a seismic wavefield, identifying a plurality of conical supports for the seismic wavefield, deriving, using at least one electronic processor, a plurality of kernels from the plurality of conical supports, decomposing, in parallel, a representation of the measured seismic wavefield in terms of the plurality of kernels to obtain a decomposition, where each of a plurality of kernels is processed by a different electronic processor, removing from the decomposition at least one kernel to remove an unwanted portion of the seismic wavefield, obtaining, based on the decomposition, an approximation of the seismic wavefield, and outputting the approximation of the seismic wavefield.

### RELATED APPLICATIONS

The present application claims priority to and the benefit of U.S. Provisional Patent Application No. 62/020,503 entitled “GENERALIZATION OF PÁDE APPROXIMATION TO ANALYTICAL FUNCTIONS” to Yarman et al., filed Jul. 3, 2014, which is hereby incorporated by reference in its entirety.

### BACKGROUND

Seismic wavefield data can be voluminous and difficult to process. For example, seismic wavefield data from a single seismic survey can be on the order of tens of terabytes. Storage of such data can be problematic, particularly when obtained from multiple survey sites at multiple times. In addition to storage difficulties, processing such data, e.g., to remove noise or echo artifacts or to model reservoir behavior, poses unique challenges due to data volume.

The Páde approximation is an approximation of a function by a rational function of given order. Under this technique, the approximant's power series agrees with the power series of the function it is approximating. The Páde approximation often gives a more accurate approximation of the function than truncating its Taylor series, and it may still work where the Taylor series does not converge. For these reasons, Páde approximations are used extensively in computer calculations.

### SUMMARY

In accordance with some embodiments, a computer-implemented method of electronically parallel processing an electronic representation of an approximation of a seismic wavefield while preserving spectral properties is presented. The method includes: obtaining, by at least one electronic processor, data representing a seismic wavefield; identifying a plurality of conical supports for the seismic wavefield; deriving, using at least one electronic processor, a plurality of kernels from the plurality of conical supports; decomposing, in parallel, a representation of the measured seismic wavefield in terms of the plurality of kernels to obtain a decomposition, where each of a plurality of kernels is processed by a different electronic processor; removing from the decomposition at least one kernel to remove an unwanted portion of the seismic wavefield; obtaining, based on the decomposition, an approximation of the seismic wavefield; and outputting the approximation of the seismic wavefield.

Various optional features of the above embodiments include the following. The decomposing may include approximating each of the plurality of kernels using a generalization of Páde approximation from rational to analytic functions. The identifying may include identifying at least one conical support corresponding to an unwanted portion of the seismic wavefield. The method may include performing a T-p transform. Each of a plurality of kernels may be processed by a different core of a graphical processing unit. The obtaining the approximation of the seismic wavefield may include solving a moment problem. The moment problem may include a ratio of Taylor series terms. The method may include acquiring the seismic wavefield data using a plurality of seismic sensors. The approximation of the seismic wavefield may preserve bandlimitedness. The outputting may include generating a human-readable presentation of the seismic wavefield data.

In accordance with some embodiments, in electronic system for parallel processing an electronic representation of an approximation of a seismic wavefield while preserving spectral properties is disclosed. The electronic system includes at least one electronic processor and at least one electronic parallel processor. The at least one electronic processor is configured to: obtain data representing a seismic wavefield; and derive a plurality of kernels from a plurality of identified conical supports. The at least one parallel processor is configured to decompose, in parallel, a representation of the measured seismic wavefield in terms of the plurality of kernels to obtain a decomposition, where each of a plurality of kernels is processed by a different electronic processor of the at least one parallel processor. The at least one electronic processor is further configured to: remove from the decomposition at least one kernel to remove an unwanted portion of the seismic wavefield; obtain, based on the decomposition, an approximation of the seismic wavefield; and output the approximation of the seismic wavefield.

Various optional features of the above embodiments include the following. The at least one parallel processor configured to decompose my be further configured to decompose by approximating each of the plurality of kernels using a generalization of Páde approximation from rational to analytic function. The at least one conical support may be identified as corresponding to an unwanted portion of the seismic wavefield. The at least one parallel processor may be configured to perform a τ-p transform. The at least one parallel processor may include at least one graphical processing unit. The at least one electronic processor may be further configured to obtain the approximation of the seismic wavefield by solving a moment problem. The moment problem may include a ratio of Taylor series terms. The system may include a plurality of seismic sensors configured to acquire the seismic wavefield data. The approximation of the seismic wavefield may preserves bandlimitedness. The system may include an electronic display configured to show a human-readable presentation of the seismic wavefield data.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a schematic diagram of a system for generating a seismic wavefield to obtain information about a subterranean reservoir.

FIG. 2 illustrates a conical support for a seismic wavefield.

FIG. 3 is a flowchart for a method according to some embodiments.

FIGS. 4A and 4B depict approximating a zero-th order Bessel function of the first kind.

FIG. 5 depicts decomposition a sinc function and a bandlimited function into chirplets.

FIG. 6 is a schematic diagram of specialized computer hardware suitable for implementing some disclosed techniques.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the claims. However, it will be apparent to one of ordinary skill in the art that embodiments may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the intended scope. The first object or step, and the second object or step, are both, objects or steps, respectively, but they are not to be considered the same object or step.

The terminology used in the description herein is for the purpose of describing particular embodiments only and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

The present disclosure provides computationally-efficient and highly-accurate techniques for representing, storing, and processing seismic survey data.

This disclosure is set forth in three sections. Section I provides a description of processing seismic wavefield data. Section II provides a description of decomposing data in terms of kernels. Section III describes specialized computing hardware suitable for implementing the disclosed techniques.

Section I: Representing and Processing Seismic Wavefield Data

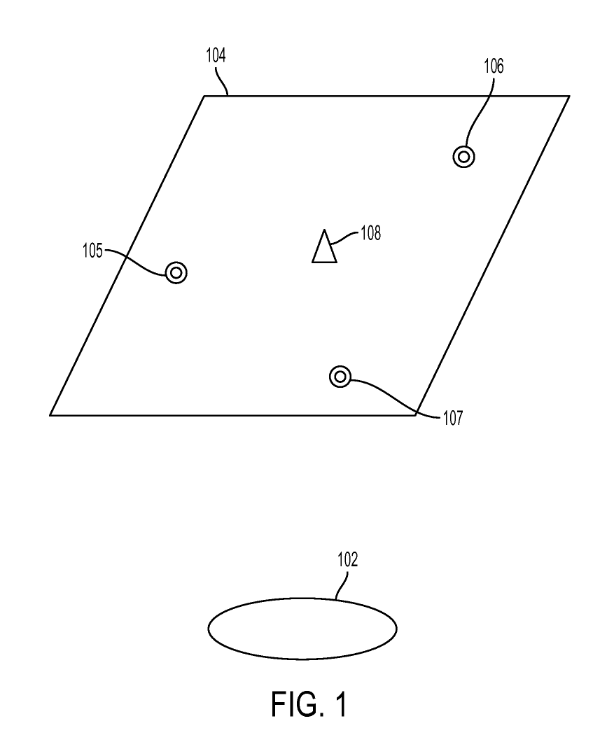

FIG. 1 is a schematic diagram of a system for generating a seismic wavefield to obtain information about subterranean reservoir 102. Thus, FIG. 1 depicts reservoir 102, such as a hydrocarbon (e.g., mixed hydrocarbon) reservoir below the Earth's surface 104. Seismic source 108, e.g., a “shot” source, generates seismic energy used to produce a seismic wavefield, which reflections and/or refractions are detected by seismic sensors 105, 106 and 107. In general, seismic source 108 produces seismic energy that is band-limited. Sensors 105, 106 and 107 detect reflections and/or refractions of the produced seismic energy, thus detecting the seismic wavefield. Sensors 105, 106 and 107 are communicatively coupled to one or more computing devices, which electronically process and/or store data representing the detected seismic wavefield.

Although example embodiments are described herein in terms of terrestrial seismic data acquisition, in general, embodiments are not so limited. Seismic wavefield data may be acquired terrestrially, using floating marine seismic sensors (e.g., “streamers”), on the sea floor, in transition zones, or elsewhere. Thus, seismic data generally need not be acquired using terrestrial sensors such as seismic sensors 105, 106 and 107 FIG. 1.

In general, physical waves, such as those of a seismic wavefield, satisfy the wave equation, which may be represented according to, by way of non-limiting example, the following.

[∂ₜ²−c²∇ₓ²]u(t,x)=0 (I.1)

In Equation (IA), the constant c is a finite parameter greater than some minimum value cₘᵢₙ, time is represented by t, and x is a point in n-dimensional space ( [symbol] ⁿ). Such time and space parameters are referred to herein as (1+n)-dimensional, or (1+n)D. Let u(t, x) be temporally band-limited, with band-limit ωₘₐₓ. Then taking the Fourier transform of Equation (I.1) produces a dispersion relation, which may be represented according to, by way of non-limiting example, the following.

|k|²=|p|²|ω|²

In the above, ω lies between −ωₘₐₓ and ωₘₐₓ, ω and k are the dual Fourier parameters of t and x, respectively, and |p|=c⁻¹ is referred to as the “slowness.”

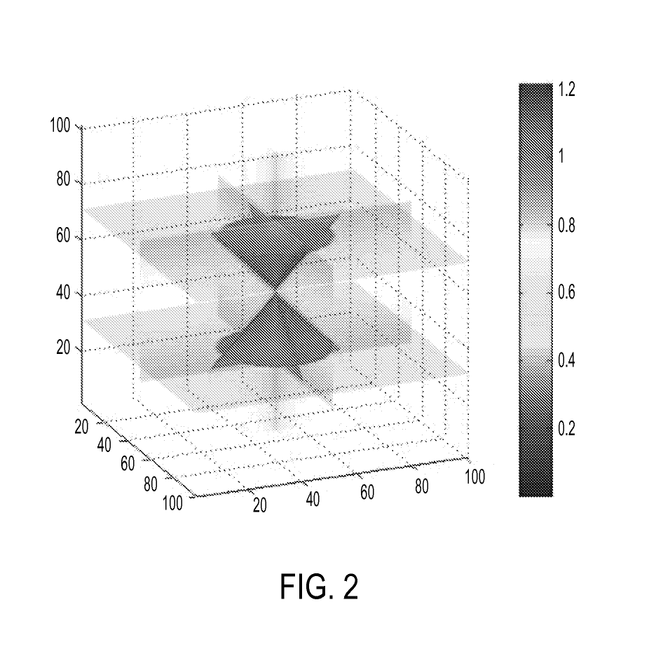

FIG. 2 illustrates a conical support for a seismic wavefield. For example, the conical support of FIG. 2, which resides in the Fourier domain, may be defined according to, by way of non-limiting example, the following.

C={(ω,k)ε [symbol] × [symbol] ⁿ:ωε[−ω₀,ω₀],|k|≦|ω|pₘₐₓ}

Such a cone may be referred to as a “wedge,” where pₘₐₓ=cₘᵢₙ⁻¹. Any function whose temporal-spatial spectrum is supported on this wedge may be referred to as “wedge band-limited.”

In general, a function ƒ_{W}(t,x) is said to be a wedge band-limited function if there is some function \tilde{ƒ}(ω,k) such that the following holds.

ƒ_{W}(t,x)=∫_{C}\tilde{ƒ}(ω,k)e^{i2π(ωt-k:x)}dωdk (I.2)

Given an integrable function ƒ(t, x), the corresponding wedge band-limited version ƒ_{W}(t, x) may be defined either by Equation (I.2) or, by way of non-limiting example, the following.

ƒ_{W}(t,x)= [symbol] ƒ(τ,y)K(2π[t−τ],2π[x−y])dτdy (I.3)

In Equation (I.3) above, the term K(t, x) may be defined according to, by way of non-limiting example, the following.

K(t,x)=∫_{C}e^{i(ωt-k:x)}dωdk (I.4)

The term K(t, x) may be referred to as the “representation kernel,” or simply “kernel,” for the band-limited functions.

Given an integrable function ƒ(t, x), its τ-p transform T[ƒ] may be defined according to by way of non-limiting example, the following.

T[ƒ](τ,p)= [symbol] ƒ(τ+x·p,x)dx

Then a τ-p transform of a wedge band-limited function may be given in terms of a τ-p transform of the representation kernel, e.g., as follows.

$$T [ {f}_{W} ] ( τ , p ) = \frac{1}{{( 2 π )}^{n}} {\int }_{{ℝ}^{n}} f ( {τ}^{′} , y ) \{ T [ K ] ( 2 π [ τ - {τ}^{′} + y \cdot p ] , p ) \} d {τ}^{′} d y \qquad ( I .5 )$$

In Equation (I.5), the term T[K] may be defined according to, by way of non-limiting example, the following.

T[K](τ,p)=(2π)ⁿ2ω₀ sinc(ω₀τ)χ_{[0,p}_{ₘₐₓ}_{]}(|p|)

In the above, the term τ is a real number, p is an n-dimensional vector, and χ_{[0,p}_{ₘₐₓ}_{]}(x) is the characteristic function, equal to one for x from zero to a, and zero otherwise.

Let g(τ, p) be a τ-p transform of a wedge band-limited function obtained by discretization of the integral of Equation (I.5) for some given sample locations, represented according to, by way of non-limiting example, the following.

g(τ,p)=ΣₙgₙT[K](2π[τ−tₙ+xₙ·p],p) (I.6)

The adjoint of the τ-p operator may be defined according to, by way of non-limiting example, the following.

T*[g](t,x)= [symbol] g(t−x·p,p)dp=Σₙgₙ[T*T][K](2π[t−tₙ],2π[x−xₙ]) (I.7)

The composition [T*T] of the representation kernel K may be represented using the generalized hypergeometric function ₁F₂ according to, by way of non-limiting example, the following.

$$[ {T}^{*} T ] [ K ] ( t , x ) = \frac{{( 2 π )}^{n} \vert {S}^{n - 2} \vert {p}_{max}^{n} π}{n} {\int }_{- {ω}_{0}}^{{ω}_{0}} {{e}^{iω t} }_{1} {F}_{2} ( \frac{n}{2} ; 1 , \frac{n + 2}{2} ; - \frac{{( ω {p}_{max} r )}^{2}}{4} ) d ω \qquad ( I .8 )$$

From the techniques disclosed in Section II, the generalized hypergeometric function ₁F₂ may be approximated according to, by way of non-limiting example, the following.

$${}_{1}^{}{F}{}_{2}^{} ( \frac{n + 1}{2} ; 1 , \frac{n + 3}{2} ; \frac{{x}^{2}}{4} ) \approx {\sum }_{m} {α}_{m , n} sinc ( {γ}_{m , n} x ) \qquad ( I .9 )$$

In Equation (I.9), the parameters (α_{m,n}, γ_{m,n}) satisfy a moment problem defined by a ratio of Taylor series coefficients of the Taylor series expansions of

$${}_{1}^{}{F}{}_{2}^{} ( \frac{n + 1}{2} ; 1 , \frac{n + 3}{2} ; \frac{{x}^{2}}{4} )$$

and sinc, as described in detail herein in Section II, below. Then the composition [T*T] of the representation kernel K may be represented according to, by way of non-limiting example, as follows.

$$[ {T}^{*} T ] [ K ] ( t , x ) \approx \frac{( 2 {π}^{n} ) \vert {S}^{n - 2} \vert {p}_{max}^{n} π}{n} {\sum }_{m} {α}_{m , n} {ω}_{0} [ \frac{t + {p}_{max} {γ}_{m , n} r}{{p}_{max} {γ}_{m , n} r} Si ( {ω}_{0} [ t + {p}_{max} {γ}_{m , n} r ] ) + \frac{t - {p}_{max} {γ}_{m , n} r}{{p}_{max} {γ}_{m , n} r} Si ( {ω}_{0} [ t - {p}_{max} {γ}_{m , n} r ] ) ] \qquad ( I .10 )$$

In Equation (I.10), Si(x) represents the sine integral function. In some implementations, a compact representation of [T*T][K](t, x), such as that given according to Equation (I.10), is desirable, particularly for embodiments that utilize a T-p implementation.

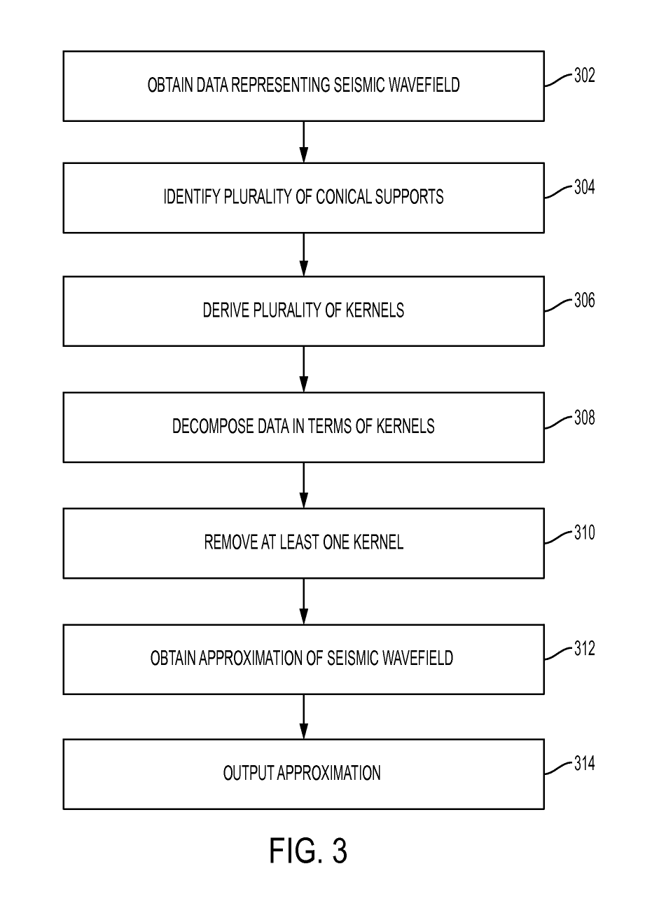

FIG. 3 is a flowchart for a method according to some embodiments. The method of FIG. 3 may be implemented using the kernel handling techniques of this section and the approximation and decomposition techniques of Section II. Further, the method of FIG. 3 may be implemented by the specialized computing hardware disclosed in Section III.

At block 302, the method obtains data representing a seismic wavefield. The data may have been originally acquired using a system such as that shown and described above in reference to FIG. 1. Further, the data may be in the form of Equation (I.3), above, e.g., as a wedge band-limited function, or more particularly, as a set of discrete samples thereof. The data may be obtained by retrieving it from persistent electronic storage and/or over an electronic network, for example.

At block 304, the method identifies a plurality of conical supports for the obtained data. The conical supports may be as defined above in reference to FIG. 2. A plurality of such supports in the Fourier domain may be selected to focus on a desired seismic wavefield signal portions and/or exclude undesirable signal portions. Example undesirable signal portions include noise, such as that generated by cable properties and/or water currents in marine embodiments. The selection may be performed manually, by an operating technician, or automatically, by a system according to some embodiments.

At block 306, the method derives a plurality of kernels from the conical supports of block 304. As disclosed above, e.g., in reference to Equation (I.4), the kernels may be derived as inverse Fourier transforms of characteristic functions of conical supports.

At block 308, the method decomposes the seismic wavefield data in terms of kernels. In general, the decomposition may be of the form set forth by Equation (I.3), expressing the wedge band-limited function representing the seismic wavefield data in terms of an integral that includes a kernel.

Per block 308, some embodiments may decompose the seismic wavefield data in terms of kernels in a particular domain particularly suitable for processing seismic wavefield data. For example, some embodiments may utilize the T-p domain, in which coordinates are transformed into pairs of slopes and intercept arrival times. In such embodiments, the seismic wavefield data may be set forth in terms of, for example, any of Equations (I.5), (I.6), or (I.7). More generally, embodiments may transform the seismic wavefield data using a Radon transform, for example.

At block 310, the method removes at least one kernel from the representation. The removed kernel(s) may correspond to the conical supports that concentrate on undesirable signal portions, such as noise, e.g., as described above in reference to block 304.

At block 312, the method obtains an approximation of the seismic wavefield. For embodiments that utilize the τ-p domain, the approximation may proceed according to the relationship expressed by Equation (I.7). More particularly, the integral side of Equation (I.7) may be set according to the empirical seismic wavefield data. Note that the values for g(τ, p) need not be stored and can be computed during the processing operations. The [T*T][K](2π[t−tₙ], 2π[x−xₙ]) term appearing on the summation side of Equation (I.7) may be expressed as set forth in Equations (I.8) or (I.10), in terms of the hypergeometric function ₁F₂ of Equation (I.9). This term may then be evaluated according to the techniques set forth in Section II, below, with the function ƒ of Section II replace by the hypergeometric function

$${}_{1}^{}{F}{}_{2}^{} * ( \frac{n + 1}{2} ; 1 , \frac{n + 3}{2} ; \frac{{x}^{2}}{4} )$$

and the function g of Section II replaced by the cardinal sine function, sinc. With the integral and summation sides of Equation (I.7) substituted as stated, the terms gₙ may be determined by solving the resulting system of linear equations. These gₙ terms may serve to approximate the seismic wavefield.

Note that the actions of this block are particularly amenable to computation by specialized computer hardware. More particularly, the computations of the gₙ terms may be performed in parallel by specialized parallel processing computer hardware. Such hardware may include, for example, one or more graphics processing units (GPUs), which may be adapted to perform the noted computations instead of performing their intended graphics processing functions. Suitable parallel processors may include multiple cores, with each core performing a separate computation, e.g., of a particular gₙ term.

At block 314, the method outputs the approximation. The output may be in any of a variety of forms. The approximation may be output in human-readable form, e.g., in terms of a graphical display. Alternately, or in addition, the approximation may be output to processing circuitry for any of a variety of manipulations, such as, by way of non-limiting example, deghosting

Section II: Approximating Data by Decomposing in Terms of Kernels

This section discloses techniques for performing certain actions used to approximate seismic wavefields. In particular, this section discloses techniques for performing certain evaluations described in detail above in reference to block 312 of FIG. 3.

More generally, this section discloses powerful techniques that have a wide variety of applications to many different technical fields. In general, the disclosed techniques can be used to approximate analytic functions in terms of other analytic functions.

For example, the methods of this section may be used to approximate Bessel functions (in terms of sinc/cosinc functions) and perform the integration of Bessel functions against other functions. Such Bessel functions may appear in the solution of partial differential equations in the cylindrical coordinates. Therefore, its application areas may include wave equations in cylindrical coordinates (e.g., computational wave propagation), electromagnetics in cylindrical waveguides (e.g., fiber optic communications, controlled-source electromagnetic method forward modeling and inversion in layered media, antenna design), and well test analysis and modelling of natural water influx into petroleum reservoirs. The Bessel functions may also apply to data processing such as seismic data from a wellbore, log measurements (e.g., electromagnetic, gamma ray, neutron, sonic, resistivity, conductivity, nuclear magnetic resonance), and interpolation of band-limited functions in cylindrical coordinates (e.g., azimuthal angle-offset gathers). The Bessel functions may further apply to representation of wedge band-limited functions for seismic data representation (as disclosed above in Section I), filtering, interpolation, and wave propagation. In another embodiment, the Bessel functions may apply to medical imaging (e.g., singular value decomposition of Radon transforms may be given in terms of Bessel functions).

The methods disclosed in this section may also be used to approximate sine integral functions. The sine integral functions may be used in computation of semi-analytic least square slant-stack (τ-p) transforms, determination of radiation patterns for antenna power design and for patterns of acoustical radiation, and finding the diffusion of heat, electromagnetic waves, and vibrations in a membrane. The sine integral functions may also be used in signal processing to manipulate signals for clarity. The sine integral functions may further be used in spectroscopy, that is, the study of the interaction between radiated energy in the form of waves and matter. The sine integral function may be part of performing the Fourier transform calculations that separate raw data out into spectra in order to plot the variations over time or location.

The methods disclosed in this section may also be used to approximate Fresnel integrals, which are used in optics and decomposition of Gaussian beams. The methods disclosed in this section may further be used to approximate sinc function in terms of sum of complex Gaussians. This may give rise to computations of chirplet parameters for representation of band-limited functions in terms of Chirplets. Chirplet decomposition may be used for time-frequency localized decomposition/analysis of band-limited functions and band-width extensions. Application areas may include synthetic aperture radar, (Fresnel) optics, and image processing. The robustness of chirplets to extreme (additive) noise makes them an ideal choice in the role of embedding patterns for resilient digital signal and image watermarking. Note that the disclosed approximation can be integrated and differentiated, because analytic functions are approximated in terms of other analytic functions.

In general, this section discloses a method to approximate integrals of the following form:

ƒ(x)=∫_{Γ}ρ(z)g(zx)dz

The integrals may be approximated by:

$$f ( x ) = {\sum }_{m = 1}^{M} {α}_{m} g ( {γ}_{m} x ) + ε ( x )$$

for some known or interpolated function:

$$f ( x ) = {\sum }_{n = 0}^{∞} {f}_{n} {x}^{n}$$

and an appropriately chosen function:

$$g ( x ) = {\sum }_{n = 0}^{∞} {g}_{n} {x}^{n}$$

where (αₘ, γₘ) is a solution of the moment problem:

$${h}_{n} = \frac{{f}_{n}}{{g}_{n}} = {\sum }_{m = 1}^{M} {α}_{m} {γ}_{m}^{n} + {ε}_{n}$$

With |εₙ|<ε for some desired error bound E.

For particular choices of g, the following special cases obtain. The first case may be a Páde approximation:

g(x)=(1−x)⁻¹.

The second case may be a discrete Fourier or Laplace transform for γₘε [symbol] or γₘε [symbol] , respectively:

g(x)=exp(i x).

The third case may be a discrete sinc-cosinc transform for γₘε [symbol] , where sinc(x)=sin(x)/x, and cosinc(x)=[1−cos(x)]/x:

g(x)=[exp(i x)−1]x⁻¹.

The fourth case may be a discrete Hankel transform:

g(x)=Jᵥ(x).

These and other applications are described herein.

In general, this section introduces a method for extending the basic idea of the Páde approximation, that of matching a prescribed number of terms in the Taylor series expansion of a given function using rational functions, to any arbitrary function holormorphic in a neighborhood of the Taylor series expansion point. More particularly, this section introduces a method for computing the approximations of Equation (II.1):

ƒ(x)≈Σₘ₌₁^{M}αₘg(γₘx) (II.1)

where (αₘ, γₘ) is a solution of the moment problem shown in Equation (II.2):

$${h}_{n} = \frac{{f}_{n}}{{g}_{n}} = {\sum }_{m = 1}^{M} {α}_{m} {γ}_{m}^{n} + {ε}_{n} \qquad ( II .2 )$$

ƒₙ and gₙ are the Taylor series coefficients of ƒ and g shown in Equations (II.3) and (II.4):

ƒ(x)=Σₙ₌₀^{∞}ƒₙxⁿ (II.3)

g(x)=Σₙ₌₀^{∞}gₙxⁿ (II.4)

The number of terms M in the sum to obtain the error tolerance ε is governed by the singular value decay of the Hankel matrix associated with the sequence hₙ, n=0, . . . ,2N. There are several methods for approximately solving the moment problem.

Referring back to Equation (II.1), if g is chosen appropriately, the approximation may exhibit comparable asymptotic growth and decay properties to ƒ. Unlike Páde approximation, the disclosed approximation also has the ability to preserve spectral properties of the function to be approximated, such as band-limitedness. Moreover, a single accurate implementation of the approximating function g may be used to generate a variety of highly accurate approximations to various functions ƒ. This may be useful for the case of special functions, which may be implemented in terms of specialized polynomial and Páde or optimal minimax approximations.

Providing the flexibility of using other functions in a Páde-type approximation may yield highly accurate approximations having additional desirable properties in the following examples. Additional properties that are preserved may include comparable asymptotic behavior to the function to be approximated, or the preservation of bandlimitedness in the approximation, or easy to integrate against certain functions, etc.

### Example 1. Approximation of Functions

The approximation may be used to approximate functions. For example, the Päde approximation to zeroth order Bessel function of the first kind J₀(x) may be expressed as Equation (II.5):

$${J}_{0} ( x ) \approx {\sum }_{m} {α}_{m} \frac{1}{1 - {γ}_{m} x} \qquad ( II .5 )$$

Using Equation (II.5), one may obtain the approximations shown in Equations (II.6), (II.7), and (II.8):

J₀(x)≈Σₘαₘ cos(γₘx) (II.6)

J₀(x)≈Σₘαₘ sinc(γₘx) (II.7)

J₀(x)≈Σₘαₘ exp(−γₘx²) (II.8)

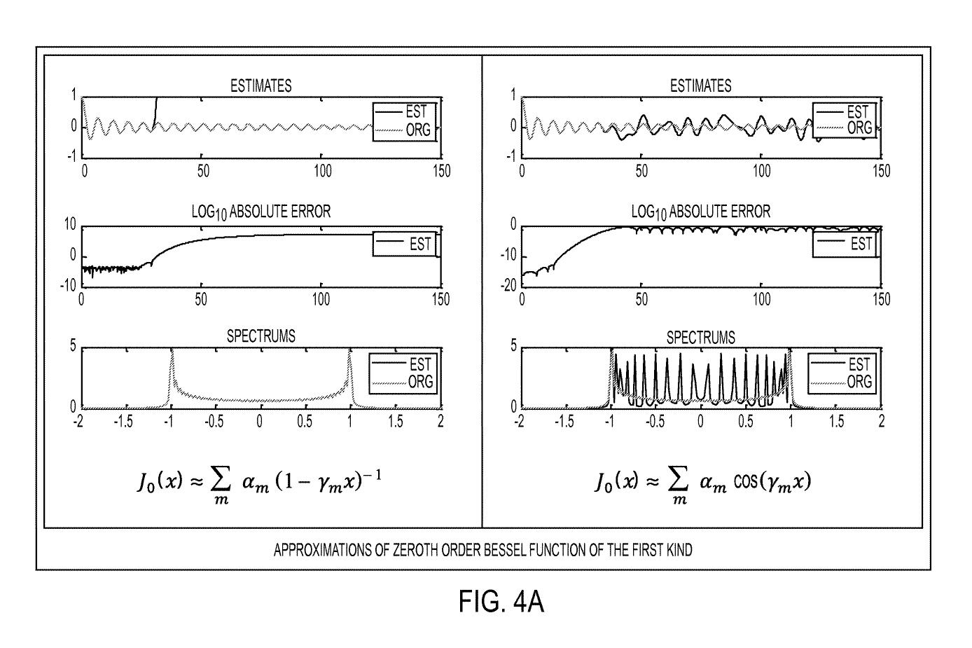

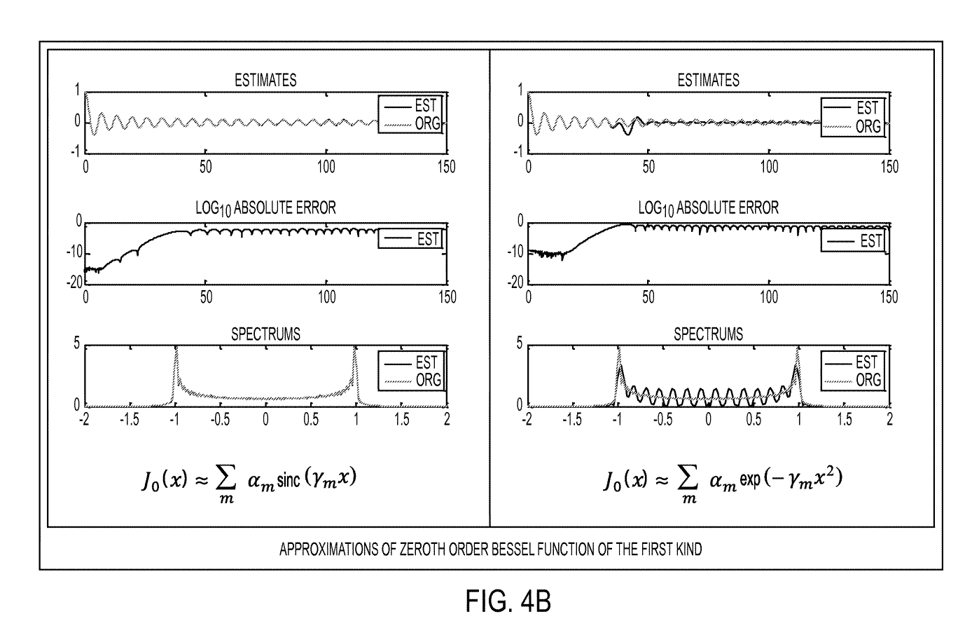

FIGS. 4A and 4B depict approximating a zero-th order Bessel function of the first kind. More particularly, FIGS. 4A and 4B depict plots of the above approximations with corresponding logarithmic absolute error and spectrums, according to an embodiment. Each of the approximations shown in FIGS. 4A and 4B have different decay properties. Among these approximations, sinc and complex Gaussian approximations may preserve the asymptotic decay properties of the J₀(x). Sinc and cosine approximations may preserve the bandwidth properties. Cosine and sinc approximations may capture the behavior of J₀(x) at zero up to machine precision, because J₀(x) has an explicit integral representation in terms of cosine and sinc. Although cosine approximation may capture the bandlimited nature of J₀(x), due to cosine's periodicity, the approximation may not capture the asymptotic behavior of J₀(x). Compared to Páde approximations, the other approximations may have a better fit to J₀(x), particularly the sinc approximation.

### Example 2. Weighted Integration

The method of approximation may be used to approximate integrals of a function ƒ with respect to other functions as shown in Equation (II.9):

∫w(x)ƒ(x)dx=Σₘ₌₁^{M}αₘ[∫w(x)g(γₘx)dx]+∫w(x)ε(x)dx (II.9)

The variable g may be selected such that [∫w(x)g(γₘx)dx] is analytically or easily integrable. For example, an approximation may be written for Jᵢ (w) as shown in Equation (II.10):

$${J}_{1} ( ω ) \approx {\sum }_{m = 1}^{M} {α}_{m} \frac{1 - cos ( {γ}_{m} ω )}{{γ}_{m} ω} \qquad ( II .10 )$$

The following integral shown in Equation (II.11) may be approximated analytically:

$${\int }_{0}^{1} {J}_{1} ( a ω ) cos ( b ω ) ω d ω \approx {\sum }_{m = 1}^{M} \frac{1}{a} \frac{{α}_{m}}{{γ}_{m}} {\int }_{0}^{1} [ 1 - cos ( {γ}_{m} a ω ) ] cos ( b ω ) d ω = {\sum }_{m = 1}^{M} \frac{1}{a} \frac{{α}_{m}}{{γ}_{m}} ( sinc ( b ) - \frac{1}{2} [ sinc ( {γ}_{m} a + b ) + sinc ( {γ}_{m} a - b ) ] ) \qquad ( II .11 )$$

This integral may arise in the computation for the kernel for wedge band-limited function of Equation (I.4), elaborated upon in Equation (II.12) below:

$$K ( t , x ) = {\int }_{C}^{ } {e}^{i ( ω t - k \cdot x )} d ω d k = \frac{4 {ω}_{0}^{2} {p}_{max}}{r} {\int }_{0}^{1} {J}_{1} ( ω r {ω}_{0} {p}_{max} ) cos ( ω {ω}_{0} t ) ω d ω \qquad ( II .12 )$$

(In Equation (II.12), C is a conical support is as defined above in Section I.) Similar integrals may arise in computation of higher-dimensional kernels where at least one of the parameters has an even dimension. A list of the higher dimensional integrals is presented in Table 1 below. The notation 1+m+n denotes a 1-D temporal dimension and m-D and n-D spatial dimensions. The approximations for m or n or both equal to 2 are approximated using the aforementioned technique.

TABLE 1
Computed and approximated kernels for wedge band limited functions

| Dimensions | Kernel |
|---|---|
| 1 + 0 | K(t) = 2sine(ω₀t) |
| 1 + 1 | $K ( t , x ) = \frac{2 {ω}_{0}}{x} ( cosine ( {ω}_{0} [ t + {p}_{max} x ] ) - cosine ( {ω}_{0} [ t - {p}_{max} x ] ) )$ |
| 1 + 2 | $K ( t , x ) \approx \frac{4 {ω}_{0}}{{r}^{2}} {\sum }_{m = 1}^{M} \frac{{α}_{m}}{{γ}_{m}} ( sine ( {ω}_{0} t ) - \frac{1}{2} [ \begin{matrix}sine ( {ω}_{0} [ t - {γ}_{m} {p}_{max} r ] ) + \\ sine ( {ω}_{0} [ t + {γ}_{m} {p}_{max} r ] )\end{matrix} ] )$ |
| 1 + 3 | $K ( t , x ) = - \frac{4 {πω}_{0}}{{r}^{3}} ( \begin{matrix}cosine ( {ω}_{0} [ t - {p}_{max} r ] ) - cosine ( {ω}_{0} [ t + {p}_{max} r ] ) - \\ r {\partial }_{r} [ cosine ( {ω}_{0} [ t - {p}_{max} r ] ) - cosine ( {ω}_{0} [ t + {p}_{max} r ] ) ]\end{matrix} )$ |
| 1 + 1 + 1 | $K ( t , x , y ) = - 2 \frac{{ω}_{0}}{xy} ( \begin{matrix}sine ( {ω}_{0} [ t + {p}_{x , max} x + {p}_{y , max} y ] ) - \\ sine ( {ω}_{0} [ t + {p}_{x , max} x - {p}_{y , max} y ] ) - \\ sine ( {ω}_{0} [ t - {p}_{x , max} x + {p}_{y , max} y ] ) + \\ sine ( {ω}_{0} [ t - {p}_{x , max} x - {p}_{y , max} y ] )\end{matrix} )$ |
| 1 + 1 + 2 | $K ( t , x , y ) \approx \frac{2 {ω}_{0}}{y {r}_{x}^{2}} {\sum }_{{m}_{x} = 1}^{M} \frac{{α}_{{m}_{x}}}{{γ}_{{m}_{x}}} ( \begin{matrix}cosine ( {ω}_{0} [ t + {p}_{y , max} y ] ) - \\ cosine ( {ω}_{0} [ t - {p}_{y , max} y ] ) - \\ cosine ( {ω}_{0} [ t + {γ}_{{m}_{x}} {r}_{x} {p}_{x , max} + {p}_{y , max} y ] ) - \\ cosine ( {ω}_{0} [ t - {γ}_{{m}_{x}} {r}_{x} {p}_{x , max} + {p}_{y , max} y ] ) + \\ cosine ( {ω}_{0} [ t + {γ}_{{m}_{x}} {r}_{x} {p}_{x , max} - {p}_{y , max} y ] ) + \\ cosine ( {ω}_{0} [ t - {γ}_{{m}_{x}} {r}_{x} {p}_{x , max} - {p}_{y , max} y ] )\end{matrix} )$ |
| 1 + 1 + 3 | $K ( t , x , y ) = \frac{16 {πω}_{0}}{r \frac{3}{x} y} [ {f}_{1} ( {ω}_{0} t , {ω}_{0} {p}_{x , max} {r}_{x} , {ω}_{0} {p}_{y , max} y ) - {ω}_{0} {p}_{x , max} {r}_{x} {f}_{2} ( {ω}_{0} t , {ω}_{0} {p}_{x , max} {r}_{x} , {ω}_{0} {p}_{y , max} y ) ]$ |
| 1 + 2 + 2 | $K ( t , x , y ) \approx \frac{4 {ω}_{0}}{{r}_{x}^{2} {r}_{y}^{2}} {\sum }_{{m}_{x} = 1}^{M} {\sum }_{{m}_{y} = 1}^{M} \frac{{α}_{{m}_{x}}}{{γ}_{{m}_{x}}} \frac{{α}_{{m}_{y}}}{{γ}_{{m}_{y}}} ( \begin{matrix}sine ( {ω}_{0} t ) - \\ \frac{1}{2} [ sine ( {ω}_{0} t - {γ}_{{m}_{x}} {r}_{x} {ω}_{0} {p}_{x , max} ) + sine ( {ω}_{0} t - {γ}_{{m}_{x}} {r}_{x} {ω}_{0} {p}_{x , max} ) ] - \\ \frac{1}{2} [ sine ( {ω}_{0} t - {γ}_{{m}_{y}} {r}_{y} {ω}_{0} {p}_{y , max} ) + sine ( {ω}_{0} t - {γ}_{{m}_{y}} {r}_{y} {ω}_{0} {p}_{y , max} ) ] + \\ \frac{1}{4} ( \begin{matrix}sine ( {ω}_{0} t - {γ}_{{m}_{x}} {r}_{x} {ω}_{0} {p}_{x , max} - {γ}_{{m}_{y}} {r}_{y} {ω}_{0} {p}_{y , max} ) + \\ sine ( {ω}_{0} t + {γ}_{{m}_{x}} {r}_{x} {ω}_{0} {p}_{x , max} - {γ}_{{m}_{y}} {r}_{y} {ω}_{0} {p}_{y , max} )\end{matrix} ) + \\ \frac{1}{4} ( \begin{matrix}sine ( {ω}_{0} t - {γ}_{{m}_{x}} {r}_{x} {ω}_{0} {p}_{x , max} + {γ}_{{m}_{y}} {r}_{y} {ω}_{0} {p}_{y , max} ) + \\ sine ( {ω}_{0} t + {γ}_{{m}_{x}} {r}_{x} {ω}_{0} {p}_{x , max} + {γ}_{{m}_{y}} {r}_{y} {ω}_{0} {p}_{y , max} )\end{matrix} )\end{matrix} )$ |
| 1 + 2 + 3 | $K ( t , x , y ) \approx \frac{8 {πω}_{0}}{{r}_{x}^{3} {r}_{y}^{2}} {\sum }_{m = 1}^{M} \frac{{α}_{m}}{{γ}_{m}} ( \begin{matrix}{g}_{0} ( {ω}_{0} t , {ω}_{0} {p}_{x , max} {r}_{x} ) - \\ {g}_{1} ( {ω}_{0} t , {ω}_{0} {p}_{x , max} {r}_{x} , {γ}_{m} {ω}_{0} {p}_{y , max} {r}_{y} ) - \\ {ω}_{0} {p}_{x , max} {r}_{x} {g}_{2} ( {ω}_{0} t , {ω}_{0} {p}_{x , max} {r}_{x} ) + \\ {ω}_{0} {p}_{x , max} {r}_{x} {g}_{3} ( {ω}_{0} t , {ω}_{0} {p}_{x , max} {r}_{x} , {γ}_{m} {ω}_{0} {p}_{y , max} {r}_{y} )\end{matrix} )$ |
| 1 + 3 + 3 | $K ( t , x , y ) = \frac{{2}^{2} {( 2 x )}^{2} {ω}_{0}}{{r}_{x}^{3} {r}_{y}^{3}} ( \begin{matrix}{f}_{1} ( {ω}_{0} t , {ω}_{0} {p}_{x , max} {r}_{x} , {ω}_{0} {p}_{y , max} {r}_{y} ) - \\ {p}_{x , max} {r}_{x} {ω}_{0} {f}_{2} ( {ω}_{0} t , {ω}_{0} {p}_{x , max} {r}_{x} , {ω}_{0} {p}_{y , max} {r}_{y} ) - \\ {p}_{y , max} {r}_{y} {ω}_{0} {f}_{2} ( {ω}_{0} t , {ω}_{0} {p}_{y , max} {r}_{y} , {ω}_{0} {p}_{x , max} {r}_{x} ) + \\ {p}_{x , max} {p}_{y , max} {r}_{x} {r}_{y} {ω}_{0}^{2} {f}_{3} ( {ω}_{0} t , {ω}_{0} {p}_{x , max} {r}_{x} , {ω}_{0} {p}_{y , max} {r}_{y} )\end{matrix} )$ |

Table 2 below provides the definitions of gᵢ, i=0,1,2,3, and ƒᵢ, i=1,2,3, which may be computed analytically.

TABLE 2
Functions used in Table 1

| Kernel | Functions used |
|---|---|
| 1 + 2 + 3 | g₀(a, b) = ∫₀¹ cos(aω)sin(bω)dω |
| | g₁(a, b, c) = ∫₀¹ cos(aω)sin(bω)cos(cω)dω |
| | g₂(a, b) = ∫₀¹ cos(aω)cos(bω)ωdω |
| | g₃(a, b, c) = ∫₀¹ cos(aω)cos(bω)cos(cω)ωdω |
| 1 + 3 + 3 | f₁(a, b, c) = ∫₋₁¹ cos(aω)sin(bω)sin(cω)dω |
| | f₂(a, b, c) = ∫₋₁¹ cos(aω)cos(bω)sin(cω)ωdω |
| | f₃(a, b, c) = ∫₋₁¹ cos(aω)cos(bω)cos(cω)ω²dω |

### Example 3. Multi-Resolution Decomposition

The technique of this section may be used for multi-resolution analysis. For example, the bandlimited functions may be decomposed into chirplets, where the chirplet parameters are derived from the decomposition of sinc in terms of chiplets as shown in Equation (II.13):

sinc(2Bπt)=Σ_{m=-M}^{M}αₘ exp(−γₘt²)+σ(t) (II.13)

Using the Shannon-Whitaker interpolation formula for bandlimited functions shown in Equation (II.14)

$${f}_{B} ( t ) = \int f ( τ ) sin c ( 2 B π [ τ - t ] ) d τ = {\sum }_{k} {f}_{B} ( {τ}_{k} ) sinc ( 2 B π [ t - {τ}_{k} ] ) , {τ}_{k} = \frac{k}{2 B} , k ∈ ℤ \qquad ( II .14 )$$

and the approximation of sinc, Equation (II15) may be expressed as shown below:

ƒ_{B}(t)≈Σ_{m=-M}^{M}αₘ[∫ƒ(τ)exp(−γₘ(τ−t)²)dτ]≈Σ_{m=-M}^{M}Σₖαₘƒ_{B}(τₖ)exp(−γₘ(τₖ−t)²) (II.15)

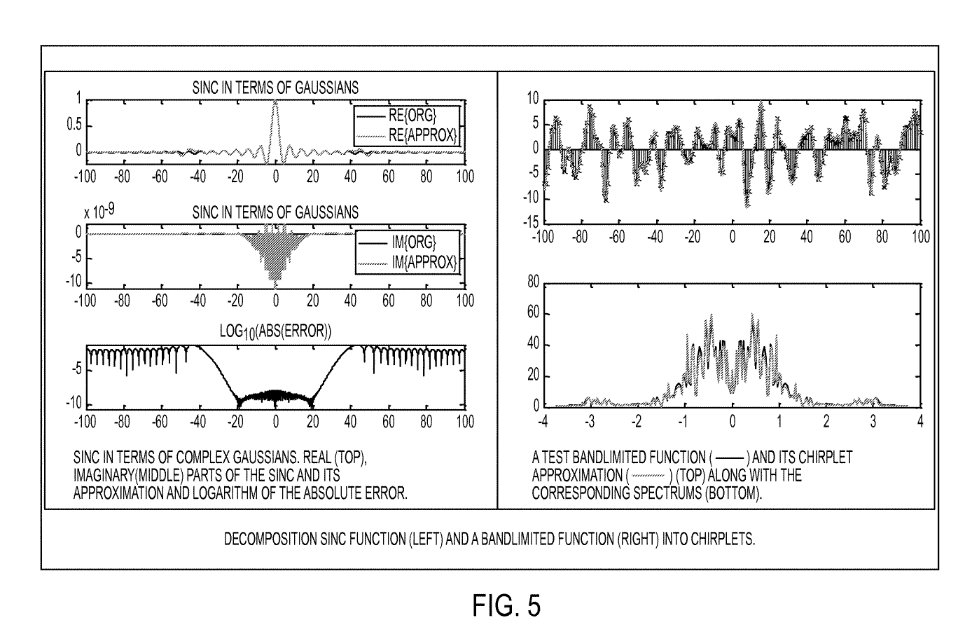

FIG. 5 depicts an approximation of sinc presented in terms of Gaussians and chiplet decomposed approximations to a band-limited function, according to an embodiment.

Section III: Specialized Computing Hardware

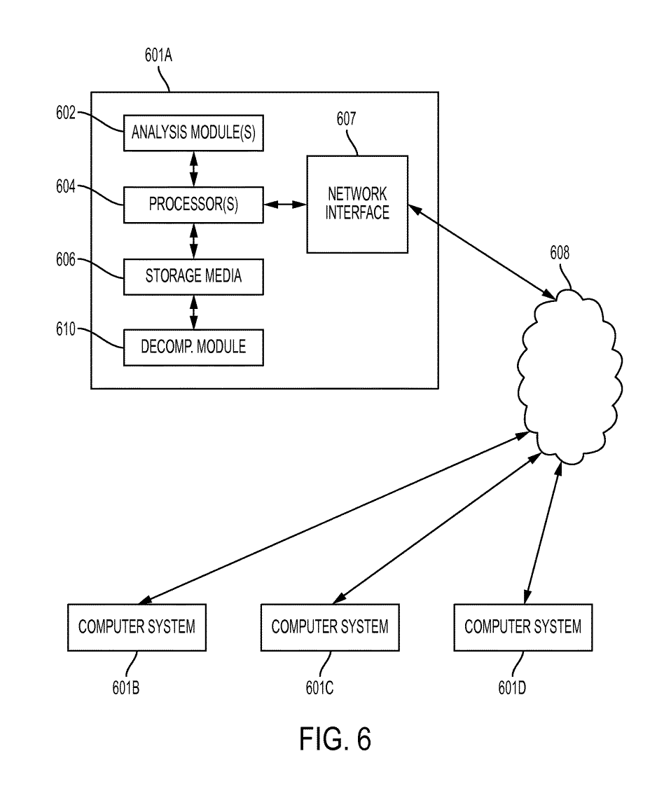

FIG. 6 is a schematic diagram of specialized computer hardware suitable for implementing some disclosed techniques. The depicted computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606A. The processor(s) 604 is (or are) also connected to a network interface 607 to allow the computer system 601A to communicate over a data network 608 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

Processor(s) 604 may generally be capable of performing highly parallel computation, e.g., as disclosed herein in reference to FIG. 3. Processor(s) 604 can include a microprocessor, microcontroller, processor module or subsystem, programmable integrated circuit, programmable gate array, or another control or computing device. Moreover, processor(s) 604 can include one or more graphical processing units (GPUs).

The storage media 606A can be implemented as one or more computer-readable or machine-readable storage media. Note that while in the example embodiment of FIG. 6 storage media 606A is depicted as within computer system 601A, in some embodiments, storage media 606A may be distributed within and/or across multiple internal and/or external enclosures of computing system 601A and/or additional computing systems. Storage media 606A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 600 contains one or more decomposition module(s) 608. In the example of computing system 600, computer system 601A includes the decomposition module 608. In some embodiments, a single decomposition module may be used to perform some or all aspects of one or more embodiments of the method of FIG. 3. In alternate embodiments, a plurality of completion quality determination modules may be used to perform some or all aspects of the method of FIG. 3.

It should be appreciated that computing system 600 is only one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, executing software, or a combination of both hardware and executing software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the contemplated scope of protection.

The foregoing description, for purpose of explanation, has been described with reference to specific embodiments. However, the illustrative discussions above are not intended to be exhaustive or to limit embodiments to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of embodiments and their practical applications, to thereby enable others skilled in the art to best utilize various embodiments with various modifications as are suited to the particular use contemplated. Additional information supporting the disclosure is contained in the appendix attached hereto.

The steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents.

What is claimed is:

1. A method of electronically parallel processing an electronic representation of an approximation of a seismic wavefield while preserving spectral properties, the method comprising:
obtaining, by at least one electronic processor, data representing a seismic wavefield;
identifying a plurality of conical supports for the seismic wavefield;
deriving, using at least one electronic processor, a plurality of kernels from the plurality of conical supports;
decomposing, in parallel, a representation of the measured seismic wavefield in terms of the plurality of kernels to obtain a decomposition, wherein each of a plurality of kernels is processed by a different electronic processor;
removing from the decomposition at least one kernel to remove an unwanted portion of the seismic wavefield;
obtaining, based on the decomposition, an approximation of the seismic wavefield; and
outputting the approximation of the seismic wavefield.

2. The method of claim 1, wherein the decomposing comprises approximating each of the plurality of kernels using a generalization of Páde approximation from rational to analytic functions.

3. The method of claim 1, wherein the identifying comprises identifying at least one conical support corresponding to an unwanted portion of the seismic wavefield.

4. The method of claim 1, further comprising performing a T-p transform.

5. The method of claim 1, wherein each of a plurality of kernels is processed by a different core of a graphical processing unit.

6. The method of claim 1, wherein the obtaining the approximation of the seismic wavefield comprises solving a moment problem.

7. The method of claim 6, wherein the moment problem comprises a ratio of Taylor series terms.

8. The method of claim 1, further comprising acquiring the seismic wavefield data using a plurality of seismic sensors.

9. The method of claim 1, wherein the approximation of the seismic wavefield preserves bandlimitedness.

10. The method of claim 1, wherein the outputting comprises generating a human-readable presentation of the seismic wavefield data.

11. An electronic system for parallel processing an electronic representation of an approximation of a seismic wavefield while preserving spectral properties, the electronic system comprising at least one electronic processor and at least one electronic parallel processor, wherein the at least one electronic processor is configured to:
obtain data representing a seismic wavefield; and
derive a plurality of kernels from a plurality of identified conical supports;
wherein the at least one parallel processor is configured to decompose, in parallel, a representation of the measured seismic wavefield in terms of the plurality of kernels to obtain a decomposition, wherein each of a plurality of kernels is processed by a different electronic processor of the at least one parallel processor; and
wherein the at least one electronic processor is further configured to:
remove from the decomposition at least one kernel to remove an unwanted portion of the seismic wavefield;
obtain, based on the decomposition, an approximation of the seismic wavefield; and
output the approximation of the seismic wavefield.

12. The system of claim 11, wherein the at least one parallel processor configured to decompose is further configured to decompose by approximating each of the plurality of kernels using a generalization of Páde approximation from rational to analytic functions.

13. The system of claim 11, wherein the at least one conical support is identified as corresponding to an unwanted portion of the seismic wavefield.

14. The system of claim 11, wherein the at least one parallel processor is configured to perform a τ-p transform.

15. The system of claim 11, wherein the at least one parallel processor comprises at least one graphical processing unit.

16. The system of claim 11, wherein the at least one electronic processor is further configured to obtain the approximation of the seismic wavefield by solving a moment problem.

17. The system of claim 16, wherein the moment problem comprises a ratio of Taylor series terms.

18. The system of claim 11, further comprising a plurality of seismic sensors configured to acquire the seismic wavefield data.

19. The system of claim 11, wherein the approximation of the seismic wavefield preserves bandlimitedness.

20. The system of claim 11, further comprising an electronic display configured to show a human-readable presentation of the seismic wavefield data.
